(19) United States
(12) Patent Application Publication
(10) Pub. No.: US 2008/0202867 A1
(43) Pub. Date: Aug. 28, 2008

(54) Bicycle Disk Brake Rotor

(75) Inventors: Martin Danzer, Adelzhausen (DE); Gregor Stuehler, Meitingen (DE); Harald Moser, Meitingen (DE)

Correspondence Address: LERNER GREENBERG STEMER LLP, P O BOX 2480, HOLLYWOOD, FL, 33022-2480, US

(73) Assignee: SGL CARBON AG, Wiesbaden (DE)

(21) Appl. No.: 12/036,314

(22) Filed: Feb. 25, 2008

(30) Foreign Application Priority Data
Feb. 23, 2007 (DE) 10 2007 009 480.0

(51) Int. Cl. B62L 1/00

(52) U.S. Cl. 188/26

(57) ABSTRACT

A bicycle disk brake rotor which is rigidly joined to the hub and can be brought into a frictional engagement with a caliper secured to the bicycle. The rotor has an inner annular region, which is joined positively and nonpositively to the hub, and an outer annular region, while the inner and outer annular region are connected by webs and the bicycle disk brake is made entirely of composite material consisting of silicon-infiltrated carbon fiber composite of a fabric structure consisting of endless fibers with a phase distribution of >60% C and 20-30% SiC.

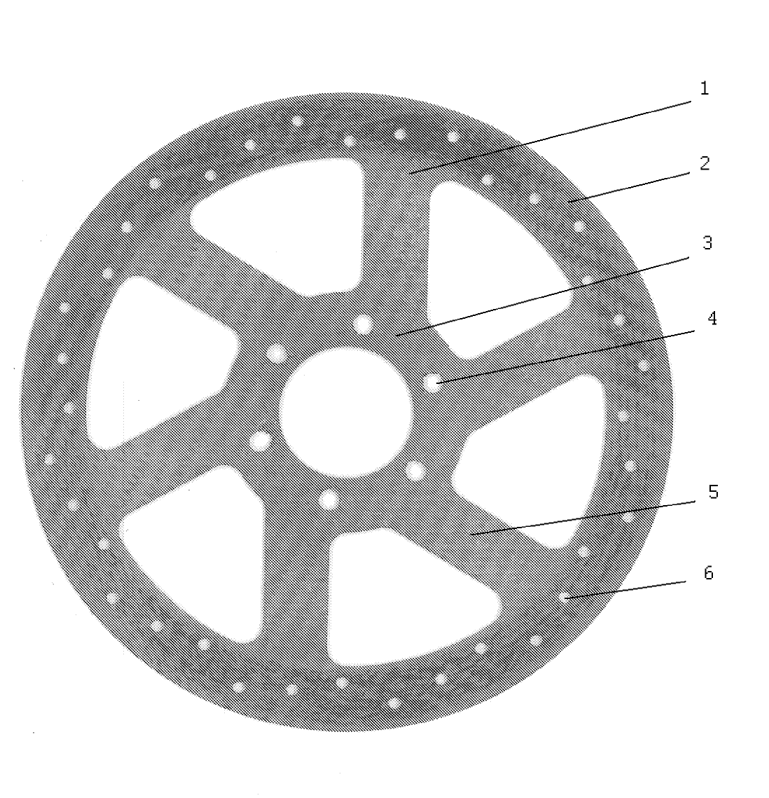

### CROSS-REFERENCE TO RELATED APPLICATION

This application claims the priority, under 35 U.S.C. § 119, of German patent application DE 10 2007 009 480.0, filed Feb. 23, 2007; the prior application is herewith incorporated by reference in its entirety.

### BACKGROUND OF THE INVENTION

### Field of the Invention

The present invention concerns a bicycle disk brake rotor, which is rigidly joined to the hub and which can be engaged in a frictional engagement with a caliper secured to the bicycle.

In principle, prior art disk brake rotors consist of a brake band and a central piece. The brake band forms the surface on which the brake linings or brake shoes exert a frictional force for the braking. The surface of the brake band and the diameter of the disk are adapted to the mass of the vehicle being braked. The central piece of the disk brake serves for fastening to the hub of the wheel being braked. As a rule, it has a large bore, through which the axle of the wheel being braked is passed, for example, in the case of a bicycle, along with a few small boreholes arranged around the large bore in a circle, through which screws are generally passed for the securing of the disk brake to the hub. As an alternative, the disk brake can also be fastened to the hub as indicated in European patent publication EP 1 288 117 A2 and U.S. Pat. No. 6,371,252 B1.

In the prior art disk brakes for bicycles, the brake band is connected to the central piece by braces. The disk brake can be a single piece or multiple piece type, and the individual pieces are preferably joined together by rivet connections. The brake band, the braces and the central piece are preferably formed from steel plate or a light metal alloy. The steel plate for bicycle disk brakes is 1 to 4 mm, generally about 2 mm thick.

A large amount of the heat generated by the braking goes into the disk. An excessive temperature rise in the disk brake causes an overheating of the brake lining. This results in damage to the material (vitrification of the surface) and heating of the brake fluid (risk of forming a vapor bubble). Moreover, in bicycle brakes, unlike those of cars, the brake lines are made of material which is not as heat-resistant, so that in the extreme situation there can occur loosening or detachment of a brake line at the caliper. Therefore, the heat must be carried away from the disk brake as soon as possible.

In bicycles, owing to the slight axial space available and the desire for light weight, single-piece or multiple-piece disk brakes of steel plate have become popular, in which the brake band is connected to the central piece by braces. Because of the relatively large torsion between the fastening of the caliper and the fastening of the disk brake, as compared to cars, it is generally necessary to use a relatively flexible material. One must tolerate the associated disadvantages of axial flexibility, as well as a tendency to audible natural vibrations (squealing) that occur especially with thin brake disks.

Prior art disk brakes for bicycles have the drawback of poor durability and relatively large unit weight. Furthermore, because the bicycle disk brakes produce no noteworthy air flow and cooling occurs primarily by the wind during riding, the heat dissipation is limited by the thermal conductivity of the material used. In normal riding conditions, this cooling is adequate, due to the low weight being braked. During long journeys, however, especially on steep terrain, problems may occur with overheating of the disk brakes. Thus, there is a need for a bicycle disk brake that lessens the drawbacks of the prior art.

### BRIEF SUMMARY OF THE INVENTION

It is accordingly an object of the invention to provide a bicycle brake disk rotor, which overcomes the above-mentioned disadvantages of the heretofore-known devices and methods of this general type and which provides for good durability, a relatively low unit weight, and good thermal conductivity.

With the foregoing and other objects in view there is provided, in accordance with the invention, a bicycle disk brake rotor configured for rigid mounting to a hub and for frictional, braking engagement with a caliper secured to the bicycle. The novel rotor comprises:

an inner annular region configured for positive and nonpositive joining to the hub;

an outer annular region forming a brake band;

a plurality of webs connecting the outer annular region to the inner annular region;

the inner annular region, the webs, and the outer annular region being formed entirely of a composite material having a fabric structure consisting of silicon-infiltrated carbon fiber composite material.

In other words, the objects of the invention are achieved with the rotor that is configured for rigidly connecting to the hub and which can be brought into a frictional engagement with a caliper secured to the bicycle. The rotor has an inner annular region (i.e., central piece), which is joined positively and nonpositively to the hub, and an outer annular region (i.e., brake band), while the inner and outer annular region are connected by webs and the rotor consisting entirely of composite material is fabricated from silicon-infiltrated carbon fiber composite.

The composite material of the bicycle disk brake consists preferably of endless fibers with a phase distribution of >60% carbon (C) and 20-30% silicon carbide (SiC).

Preferably, at least three equidistantly arranged webs are present in the bicycle disk brake rotor, and in especially preferred manner the equidistantly arranged webs are placed in a tangential orientation to the hub opening.

The bicycle disk brake can be presented in differential or integral design, that is, the brake band consisting of fiber-reinforced ceramic can also be connected to the hub in differential design, in order to adapt the properties of the overall disk brake in terms of comfort and performance.

Furthermore, the webs of the bicycle disk brake rotor are preferably broadened in the transitional region toward the central piece and in the transitional region toward the brake band.

According to one embodiment of the invention, the brake band of the bicycle disk brake has openings arranged on at least one circular line. In one advantageous embodiment, the openings are arranged on two circular lines of the brake band, and the openings cover the entire lining width in the course of one rotation.

Preferably, the brake band of the rotor is provided with a frictional layer consisting of silicon carbide (SiC) on both sides.

The bicycle disk brake rotor of the invention preferably has a thickness of 1.5 to 2.5 mm.

Other features which are considered as characteristic for the invention are set forth in the appended claims.

Although the invention is illustrated and described herein as embodied in bicycle disk brake, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The FIGURE is a side view of the disk brake rotor.

### DETAILED DESCRIPTION OF THE INVENTION

The brake disk rotor illustrated in the drawing FIGURE is adapted for use with other conventional components of a disk brake assembly, such as the caliper, as well as the brake lever and the caliper and brake pads. The additional components are well-known to those of skill in the art and they will not be described in any detail. The FIGURE illustrates the brake disk 1, or rotor 1. The rotor 1 is shown in its position in which it is mounted, namely, looking from the side of the bicycle. The rotor 1 consists of a carbon fiber prepreg crossply, 2 mm thick, which has been infiltrated with silicon. The rotor 1 is integrally formed in a single piece. The rotor primarily comprises a brake band 2, a center piece 3 with openings 4 to fasten the rotor or brake disk 1 on a hub, and braces or webs 5, which join the center piece 3 to the brake band 2.

The brake band 2 and the braces have such a high thermal conductivity that an overheating of the brake lining, the brake fluid and the brake lines is reliably prevented.

The rotor 1, moreover, is formed with boreholes 6 in the brake band 2, in order to further improve its cooling and cleaning, and also to provide for a lower weight. Of course, the rotor and the disk brakes of the invention can be used in a manner familiar to the practitioner on the front or rear wheel hub, consistent with existing brake systems.

The bicycle disk brake rotor of the invention has a high thermal conductivity and high durability, such as is required for braking from high speeds over a long time, as during long downhill runs in the countryside. Furthermore, thanks to the good strength values and the slight thickness of the material, the weight of the novel bicycle disk brake can be reduced significantly as compared to prior art bicycle disk brakes.

1. A bicycle disk brake rotor configured for rigid mounting to a hub and for frictional, braking engagement with a caliper secured to the bicycle, the disk brake rotor comprising:
an inner annular region configured for joining to the hub;
an outer annular region forming a brake band;
a plurality of webs connecting said outer annular region to said inner annular region;
said inner annular region, said webs, and said outer annular region being formed entirely of a composite material having a fabric structure consisting of silicon-infiltrated carbon fiber composite material.

2. The bicycle disk brake rotor according to claim 1, wherein said composite material is formed of endless fibers with a phase distribution of >60% C and 20-30% SiC.

3. The bicycle disk brake rotor according to claim 1, wherein said plurality of webs includes at least three equidistantly arranged webs.

4. The bicycle disk brake rotor according to claim 3, wherein said webs extend towards said brake band in integral manner and equidistantly in tangential orientation to the hub opening.

5. The bicycle disk brake rotor according to claim 1, wherein said inner annular region, said webs, and said outer annular region are integrally formed in one piece.

6. The bicycle disk brake rotor according to claim 1, wherein said inner annular region, said webs, and said outer annular region are formed in two or three, rigidly interconnected pieces.

7. The bicycle disk brake rotor according to claim 1, wherein said inner annular region, said webs, and said outer annular region are separate elements rigidly connected to one another.

8. The bicycle disk brake rotor according to claim 1, wherein said webs are widened in a transitional region toward said inner annular region and in a transitional region toward said brake band.

9. The bicycle disk brake rotor according to claim 1, wherein said outer annular region is outwardly bounded by a circular edge.

10. The bicycle disk brake rotor according to claim 1, wherein said outer annular region is outwardly bounded by line following an undulating course covering an entire lining width in the course of one rotation.

11. The bicycle disk brake rotor according to claim 1, wherein said outer annular region has openings formed therein along an inner circular line and an outer circular line, respectively, and wherein the openings formed on said inner circular line are arranged substantially centrally relative to the openings of said outer circular line.

12. The bicycle disk brake rotor according to claim 1, wherein said outer annular region is covered on both sides with a friction layer consisting of SiC.

13. The bicycle disk brake rotor according to claim 1, wherein said disk brake rotor has a thickness of 1.5 to 2.5 mm.

14. The bicycle disk brake rotor according to claim 1, wherein said inner annular region is configured for positively and nonpositively joining to the hub.
